(19) United States
(12) Patent Application Publication
(10) Pub. No.: US 2011/0225887 A1
(43) Pub. Date: Sep. 22, 2011

(54) Fresh air safety bars

(76) Inventor: Randy Manier, Ontario, CA (US)

(21) Appl. No.: 12/932,967

(22) Filed: Mar. 10, 2011

Related U.S. Application Data
(60) Provisional application No. 61/340,093, filed on Mar. 11, 2010.

(51) Int. Cl. E06B 9/01

(52) U.S. Cl. 49/56

(57) ABSTRACT

The present invention provides a product line of precisely fitted, flow-through, hinged metal frames, analogous to exterior shutters, but mounted on the interior of the building, designed to be permanently mounted to windows and sliding-glass doors, and to swing and lock into the opening created when the window or door is opened, allowing the free flow of fresh air and preventing any forced entry or intrusion. The size of the grid-style frame depends on the on the style of window, traditional sliding-sash, casement, etc., or door being fitted. In each case, the Fresh Air Safety Bars frame are double-hinged on one side, and feature a pre-drilled mounting plate, welded or bolted to the hinge assembly. This mounting plate is fastened to the wall immediately adjacent to the window or sliding-glass door. Each Fresh Air Safety Bars unit, once mounted in proper position and alignment with the window or door to be fitted, swings on its hinges to snugly and securely occupy the window or door opening.

### CLAIM OF PRIORITY

This patent application claims priority under 35 USC 119(e) (1) from U.S. Provisional Patent Application Ser. No. 61/340,093 filed Mar. 11, 2010, of common inventorship herewith entitled, “Fresh Air Safety Bars.”

### FIELD OF THE INVENTION

The present invention pertains to the field of screen door and window devices, and more specifically to the field of security screen door and window devices.

### BACKGROUND OF THE INVENTION

The prior art has put forth several designs for security screen door and window devices. Among these are:

U.S. Pat. No. 5,018,302 to Richard G. Kluge describes a burglar bar assembly for establishing a security barrier across a door or window opening composed of a plurality of horizontal cross bars held in vertically spaced relation by intervening and transversely related vertical members.

U.S. Pat. No. 6,141,912 to James A. Graham and Charles Flanagan describes a window guard for a window opening to prevent a child or animal from passing through a window. The guard includes side frames fastened to the sides of a window frame and a plurality of spaced-apart, transverse, tubular, width-adjustable crosspiece elements to form a grid pattern between the side supports to prevent passage of a child or animal.

U.S. Pat. No. 6,405,497 to George Christopolous describes a gate for sliding windows or doors in a frame. The gate provides two gate elements. The first element is attached to the window frame. The second element is attached to the sliding window. The two elements are coupled together to allow each element to slide across the other. The elements are positioned in the frame to create a barrier in a space created when a window is slid to an open position.

U.S. Pat. No. 6,680,669 to Dan Terry describes a remotely releasable security system for securing a barrier across a window opening to prevent unauthorized access to the interior of a building via a window, and to permit removal of the barrier for escape in an emergency or for maintenance.

None of these prior art references describe the present invention.

### SUMMARY OF THE INVENTION

It is an object of the present invention to provide an improved security screen door and window device comprising fitted, flow-through, hinged metal frames, analogous to exterior shutters, but mounted on the interior of the building, designed to be permanently mounted to the windows and sliding-glass doors, and to swing and lock into the opening created when the window or door is opened, allowing the free flow of fresh air and preventing any forced entry or intrusion.

### BRIEF DESCRIPTION OF THE DRAWINGS

FIG. 1 is an elevational angled perspective view of the device of the present invention in the closed configuration.

FIG. 2 is an elevational angled perspective view of the device of the present invention in the open configuration

FIG. 3 is an elevational view of a second embodiment of the present invention in the open configuration.

FIG. 4 is an elevational view of a second embodiment of the present invention in the closed configuration.

FIG. 5 is an elevational view of a third embodiment of the present invention in the closed configuration.

FIG. 6 is an elevational view of a third embodiment of the present invention in the open configuration.

FIG. 7 is an elevational view of a third embodiment of the present invention in the mid-open configuration.

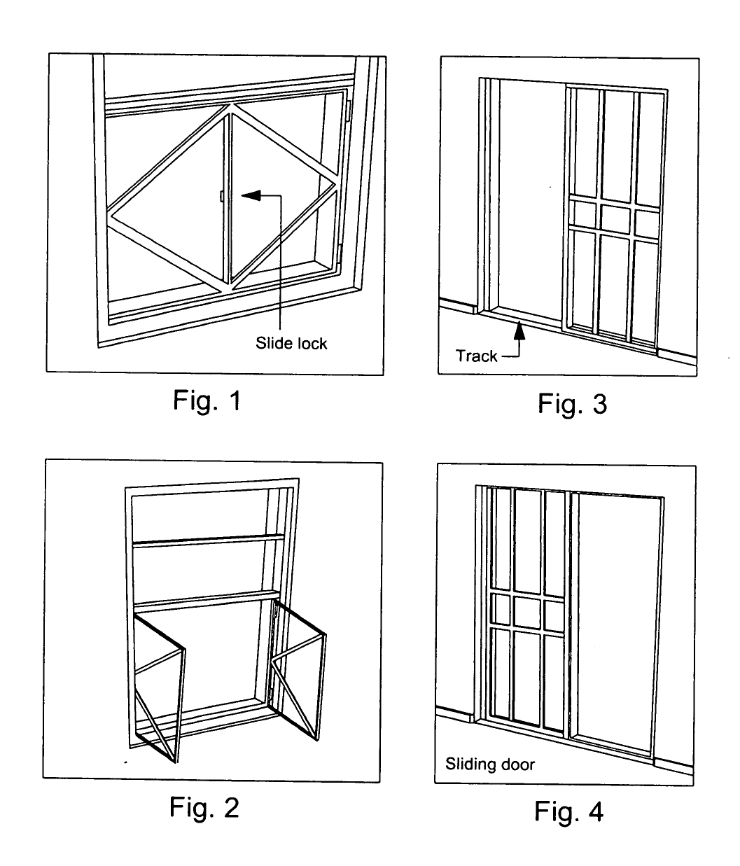

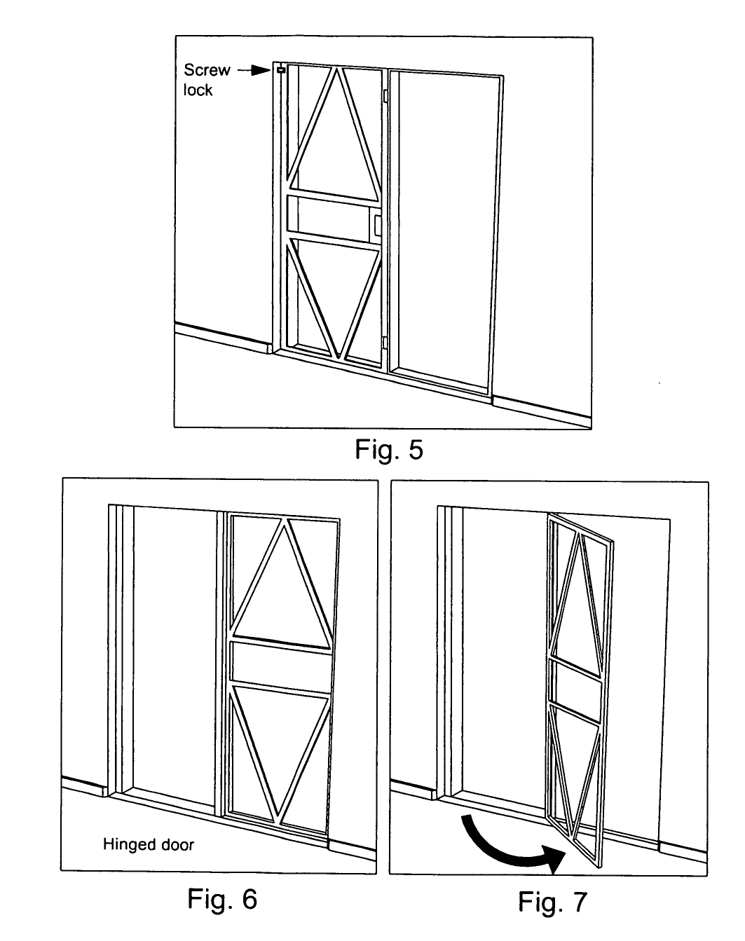

### DETAILED DESCRIPTION OF THE INVENTION

The word “window” comes to us from the Scandinavians who invaded and settled in England in the early Middle Ages. A compound made up of vindr, for “wind,” and auga, for “eye,” the Norse “wind-eye” became the English “window” reflecting the fact that, for most of human history, windows contained no glass. They did let in light and they gave their owners a view of the world outside, but windows were simply openings in walls, eyes through which the wind blew. Today we speak of windows with words less poetic than “wind-eye,” but in each case, the window is seen as an opening, a portal through which something passes, as light passes through clear glass.

Glass windows let in the light of the world, affording us a view while protecting us from the extremes of temperature and humidity. Windows and sliding-glass patio, balcony, or porch doors are essential features of a dwelling or other structure but the very fact that they open and close creates an unfortunate problem. Windows and sliding-glass doors are the weakest points in a dwelling, and invite illegal entry. There was a time, in most parts of the country, where a householder could leave the windows open with full peace of mind, but that time is past. Nowadays, an open window is an open invitation to a burglar, home-invader, or thief on the prowl.

The present invention, hereinafter referred as the Fresh Air Safety Bars is a product line of precisely fitted, flow-through, hinged metal frames, analogous to exterior shutters, but mounted on the interior of the building, designed to be permanently mounted to the windows and sliding-glass doors, and to swing and lock into the opening created when the window or door is opened, allowing the free flow of fresh air and preventing any forced entry or intrusion. Manufactured by the Metal Doors, Sash, Trim, and Molding industry, Standard Industrial Code 3442, the Fresh Air Safety Bars are fabricated of three-quarters of an inch square tube steel or heavy-gauge aluminum pipe. This pipe is fashioned in a relatively tight grid pattern and underlain by a wire-mesh screen to prevent passage of insects. The steel or aluminum framing is powder-coated to prevent rust and corrosion. The size of the grid-style frame depends on the on the style of window, traditional sliding-sash, casement, etc., or door being fitted. In each case, the Fresh Air Safety Bars frame are double-hinged on one side, and feature a pre-drilled mounting plate, welded or bolted to the hinge assembly. This mounting plate is fastened to window and doors. Each Fresh Air Safety Bars unit, once mounted in proper position and alignment with the window or door to be fitted, swings on its wall-mounted hinges to snugly and securely occupy the window or door opening. Locking hardware fixes and secures the Fresh Air Safety Bars unit in position, denying entry to intruders, yet allowing the free and easy flow of fresh air. When not in use, the Fresh Air Safety Bars unit are unlocked by a simple reversal of the locking mechanism, then swung inward, away from the door or window opening to a position flush against the adjacent wall, where a catch-hook secures the frame until its next use.

The Fresh Air Safety Bars, a product line of form-fitting, hinged, permanently mounted, flow-through safety frames for windows and doors, presents consumers with peace of mind, the knowledge that their windows and sliding-glass doors are secure against intruders, yet allowing the free flow of fresh air. Unlike permanently mounted, exterior window bars, the Fresh Air Bars are concealed from view when not in use, and put in place for protection only when the window or sliding-glass door is opened. Further, the Fresh Air Bars require no tedious and time-consuming installation for each use. Once the Fresh Air unit is fitted and installed for a window or door opening, the Safety Bars frame, hinged and out of the way, is simply released from its wall-catch, then swung on its hinges and into position in the door or window opening, where a simple but effective mechanism locks it securely into place. And the initial installation of the Fresh Air Safety Bars is accomplished in an hour or so by any competent carpenter or do-it-yourself handyman. Equipped with three-quarter-inch steel or heavy-gauge aluminum welded in an intrusion-repelling grid pattern, the Fresh Air Safety Bars are backed with a fine mesh screen, protecting the interior of the home not only from human intruders, but from pests and insects as well.

The Fresh Air Safety Bars are built of high-quality materials and fabricated to provide a long, trouble-free working life, providing consumers with both fresh air and heightened security.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A safety frame for a window or door, comprising form-fitted, flow-through, hinged metal frames, analogous to exterior shutters, but permanently mounted on the interior of the building, to windows, hinged doors and sliding-glass doors, to swing and lock into the opening created when the window or door is opened, allowing the free flow of fresh air and preventing any forced entry or intrusion.

2. The safety frame of claim 1 fabricated of square tube steel or heavy-gauge aluminum pipe, wherein the pipe is configured in a tight grid pattern and underlain by a wire-mesh screen to prevent passage of insects.

3. The safety frame of claim 2 wherein the steel or aluminum framing is powder-coated to prevent rust and corrosion.

4. The safety frame of claim 1 further comprising a double-hinge on one side, and a pre-drilled mounting plate, welded or bolted to the hinge assembly, wherein the mounting plate is fastened to the window or sliding-glass door.

5. The safety frame of claim 1 further comprising locking hardware.
